(19) United States
(12) Patent Application Publication
(10) Pub. No.: US 2024/0129968 A1
(43) Pub. Date: Apr. 18, 2024

(54) METHODS, ARCHITECTURES, APPARATUSES AND SYSTEMS FOR SUPPORTING MULTIPLE APPLICATION IDS USING LAYER-3 RELAY

(71) Applicant: InterDigital Patent Holdings, Inc., Wilmington, DE (US)

(72) Inventors: Michelle Perras, Montreal (CA); Alec Brusilovsky, Downingtown, PA (US); Samir Ferdi, Kirkland (CA); Saad Ahmad, Montreal (CA)

(21) Appl. No.: 18/277,437

(22) PCT Filed: Feb. 15, 2022
(86) PCT No.: PCT/US2022/016415

§ 371 Date: Aug. 16, 2023

Related U.S. Application Data
(60) Provisional application No. 63/150,275, filed on Feb. 17, 2021.
(60) Provisional application No. 63/253,804, filed on Oct. 8, 2021.

(51) Int. Cl. H04W 76/14; H04L 61/5007

(52) U.S. Cl. CPC H04W 76/14; H04L 61/5007; H04W 88/04

(57) ABSTRACT

The disclosure pertains to methods and apparatus for supporting multiple application IDs on a single unicast link using Layer-3 Relay. Methods and apparatus for operation by a wireless transmit/receive unit (WTRU) are provided. In an embodiment, a method may include any of receiving a first request message to establish a direct communication with a peer WTRU, the request message including an indication of first user information of the peer WTRU, associated with a first application and/or a first application identity; transmitting, to the peer WTRU, information indicating a first Internet Protocol (IP) address; receiving a second request message to associate a second application with the direct communication; transmitting a second response message including a second IP address; and communicating, with the peer WTRU using the direct communication, data related to the first application using the first IP address and data related to the second application using the second IP address.

### CROSS-REFERENCE TO RELATED APPLICATIONS

This application claims the benefit of U.S. Provisional Patent Application Nos. (i) 63/150,275 filed Feb. 17, 2021, and (ii) 63/253,804 filed Oct. 8, 2021; each of which is incorporated herein by reference.

### FIELD

The present disclosure is generally directed to the fields of communications, software and encoding, including, for example, to methods, architectures, apparatuses, systems directed to support multiple application IDs on a single unicast link using Layer-3 Relay.

### BACKGROUND

5G Proximity Services (ProSe) allows Wireless Transmit Receive Units (WTRUs) in a wireless network to act as relays for other WTRUs in order to transmit data (and/or control information) between nodes of the network. However, current procedures for WTRU to WTRU relay in 5G are inefficient.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to one embodiment;

FIG. 1C is a system diagram illustrating an example radio access network (RAN) and an example core network (CN) that may be used within the communications system illustrated in FIG. 1A according to one embodiment;

FIG. 1D is a system diagram illustrating a further example RAN and a further example CN that may be used within the communications system illustrated in FIG. 1A according to one embodiment: and

FIG. 2 is a signal flow diagram illustrating WTRU-to-WTRU relay as specified in 3GPP Technical Report 23.752 v1.0.0;

FIG. 3 is a signal flow diagram illustrating the addition of support of a new application to an existing PC5 unicast link with a WTRU-to-WTRU relay in accordance with an embodiment;

FIG. 4 is a signal flow diagram illustrating the removal of support of an application from a PC5 unicast link with a WTRU-to-WTRU relay in accordance with an embodiment; and

FIG. 5 is a signal flow diagram illustrating triggering the use of a new application at another WTRU via an existing PC5 unicast link established with a specific Relay in accordance with an embodiment.

FIG. 6 is a flowchart illustrating a representative method implemented by a WTRU illustrating the addition of support of a new application to a direct communication between the WTRU and a peer WTRU.

FIG. 7 is a flowchart illustrating a representative method implemented by a relay WTRU, for relaying communications between first and second other WTRUs.

### DETAILED DESCRIPTION

### 1. Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### 2. Example Communications System

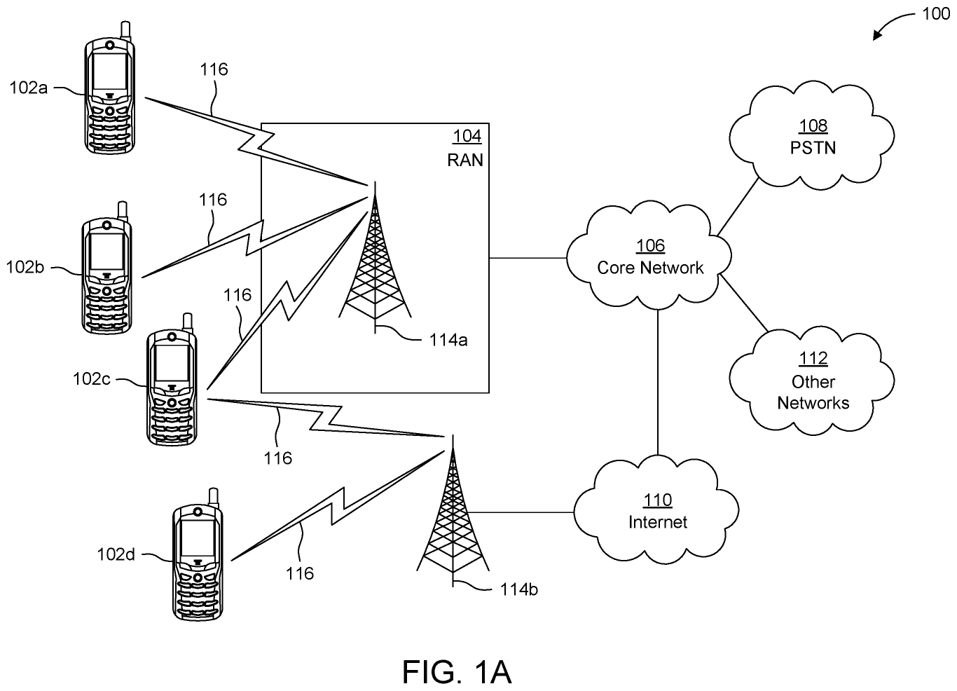

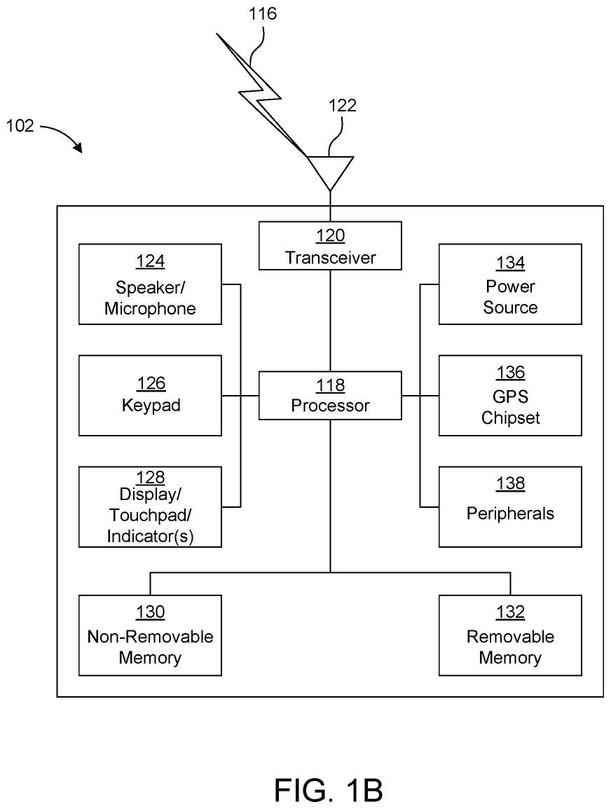

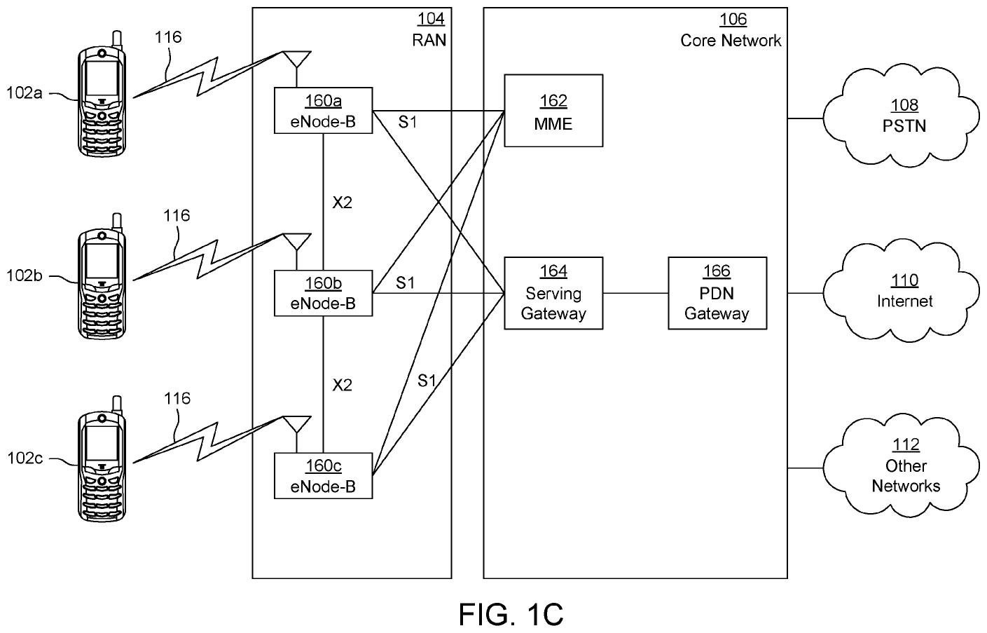

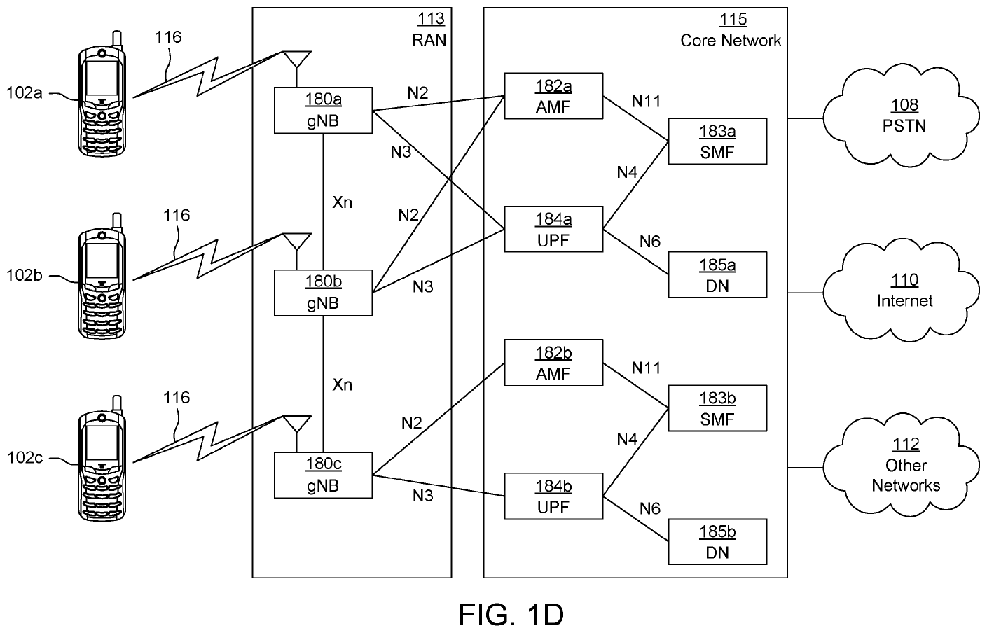

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 3. ProSe WTRU-to-WTRU Relay—IP Routing in Release 17

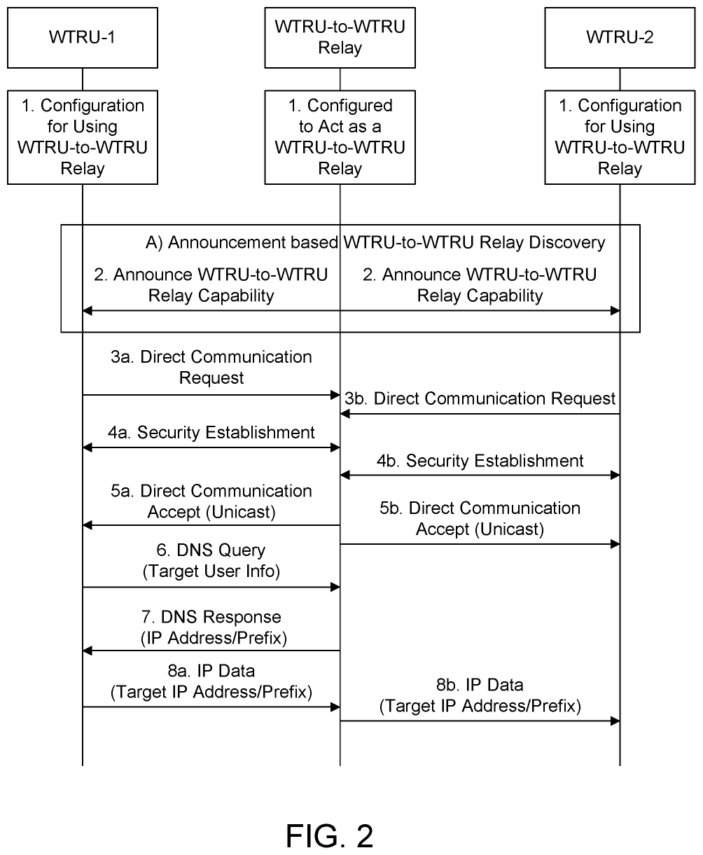

In 3GPP, Technical Report TR 23.752 v1.0.0, section 6.10 details a WTRU-to-WTRU relay solution based on IP routing as illustrated in FIG. 2 (reproduced from TR 23.752 v1.0.0).

Any WTRU that wants to make use of the Proximity Services (ProSe) 5G WTRU-to-WTRU relay may (e.g., needs to) establish a unicast L2 link (e.g., PC5 unicast link) with the WTRU-to-WTRU relay. If there are multiple ProSe 5G WTRU-to-WTRU relays in proximity, the WTRU may establish a PC5 unicast link with each of the relays. For example, if WTRU1 can reach five relays, then it may establish 5 different PC5 unicast links, e.g., one per relay. WTRU1 may receive a different IP address/prefix per PC5 unicast link.

As part of the unicast L2 link establishment procedure, the ProSe 5G WTRU-to-WTRU relay may allocate an IP address/prefix to the WTRU, may store an association of the WTRU's user information and/or allocated IP address/prefix into its Domain Name System (DNS) entries. The ProSe 5G WTRU-to-WTRU relay may act as a DNS server.

If (e.g., when) a (source) WTRU wants to (e.g., needs to) communicate with another (target) WTRU or wants to (e.g., needs to) discover a ProSe service via the ProSe 5G WTRU-to-WTRU relay, it may send a DNS query for the target WTRU (for example, based on Target user information) or for the ProSe Service to the ProSe 5G WTRU-to-WTRU relay over the unicast link, which may return the IP address/prefix of the target WTRU or the ProSe Service (e.g., in a DNS response).

The source WTRU may send the IP data (or non-IP data encapsulated in IP) to the target WTRU, for example, via the unicast L2 link to the WTRU-to-WTRU relay that may return the IP address/prefix of the target WTRU (e.g., DNS response). The ProSe 5G WTRU-to-WTRU relay may act as an IP router, and may forward the packets to the corresponding unicast L2 link toward the target WTRU. Any (e.g., each) of the unicast L2 links may be treated as an IP interface.

If there are multiple ProSe 5G WTRU-to-WTRU relays in the proximity, the source WTRU can choose any one or more ProSe 5G WTRU-to-WTRU relays to establish the unicast L2 link based on WTRU implementation. For example, the WTRU may send a DNS query on each of the unicast L2 links to the ProSe 5G WTRU-to-WTRU relays. Then, for example, the source WTRU may choose to use the first ProSe 5G WTRU-to-WTRU relay that returns a positive DNS response for the target WTRU.

The Layer-3 WTRU-to-WTRU relay solution in TR 23.752 v1.0.0 as described above may support the registration of a WTRU's user information (or supported application ID) with multiple relays. As is known, the WTRU's user information may be specific to a ProSe Service (or application ID).

In accordance with the Layer-3 WTRU-to-WTRU relay solution as described above, any (e.g., all) WTRUs that want to use L3 relays may establish a PC5 unicast link and/or may register their user information (or supported ProSe Service) with any (e.g., all) reachable relays and/or may obtain an IP address from any (e.g., each) of those relays. For example, WTRU1 may establish a PC5 unicast link with relay 1 (obtains IP1), relay2 (obtains IP2), relay3 (obtains IP3) for, e.g., “WTRU1 user info_1” (or ProSe Application ID_1).

If WTRU1 wants to use ProSe Application ID_2, then it may (e.g., needs to) establish a second PC5 unicast link with the same relays since the PC5 unicast link is per application ID. Indeed, WTRU1's user information, for example, as specified on the Direct Communication Request (DCR) message may be specific to the application ID. For example, if ten relays are reachable by WTRU1, and WTRU1 wants to support five application IDs, then 50 unicast links may (e.g., need to) be established with 50 different IP addresses assigned to WTRU1 (e.g., five unicast links between WTRU1 and each relay and one IP address/prefix per PC5 unicast link multiplied by ten relays).

Having so many PC5 unicast links may be problematic since PC5 signaling may (e.g., is needed to) keep these unicast links alive, e.g., keepalives may be exchanged, Link Identifier Update procedure may be executed periodically, etc. The context information for unicast links may be saved locally on the WTRUs and in the relays and may consume memory and processing resources.

Accordingly, the current Layer-3 WTRU-to-WTRU relay solution as currently described may not be reasonably scalable. Thus, it would be desirable to support multiple ProSe Applications running on a WTRU via WTRU-to-WTRU relays without exhausting the local resources and/or without generating excessive PC5 signaling so that support of multiple ProSe Applications is more scalable from both the relay and WTRU perspectives.

### 4. Terminology

In an embodiment the terms Source WTRU (S-WTRU) and Target WTRU (T-WTRU) are used to identify peer WTRUs. In this specification, A S-WTRU may also be referred to as an initiating WTRU, or a peer WTRU. Likewise, a T-WTRU may also be referred to as a responding WTRU, a target WTRU, or a peer WTRU. Additionally, any WTRU also may be referred to as a WTRU or Wireless Transmit/Receive Unit.

Further, a WTRU-to-WTRU relay refers to a WTRU behaving as a relay between two peer WTRUs, and may be referred to shorthand as a R-WTRU, relay WTRU, or relay. In addition, ProSe Application ID, ProSe Service ID, ProSe Service are used interchangeably and WTRU's ProSe Application Layer ID, WTRU's ProSe User Info, WTRU's application Layer ID and WTRU's User Info are used interchangeably. The terms unicast link and direct communication are used interchangeably. Finally, whenever the term IP address is used, it may be substituted with IP prefix.

### 5. Support for Scalable WTRU-to-WTRU Relay

5.1 Overview

A procedure to support multiple applications (e.g., user information and/or application IDs) on a single (e.g., PC5) unicast link/direct communication with a relay is summarized below.

In an embodiment, support of a new application ID/user information is added. Specifically, an S-WTRU may use a request message (e.g., the Link Modification Request message) to add support of an application ID on an existing (e.g., PC5) unicast link/direct communication with a relay. The request message (e.g., Link Modification Request) may specify the WTRU's user information associated with the new application and/or the new application ID and a “new IP address needed” indication. The S-WTRU also may indicate specific policies (e.g., security, privacy, QoS) applicable to the added application.

The S-WTRU may send a request message (e.g., Link Modification Request message) to any (e.g., every) relay with which a (e.g., PC5) unicast link/direct communication is established to register its new user information and/or application ID.

The relay may receive the request message (e.g., Link Modification Request message) and may save the new WTRU's user information (and/or application ID), for example, locally (e.g., into a mapping table), in addition to the existing user Information/Application ID that may be already registered on this (e.g., PC5) unicast link/direct communication. If the new IP address indication is specified (e.g., is set to TRUE), a new IP address may be assigned to the S-WTRU in addition to the existing IP address associated with the (e.g., PC5) unicast link/direct communication, and correlated with the new registered user information and/or application ID.

The existing IP address associated with the (e.g., PC5) unicast link/direct communication may be re-used with the new user information and/or application ID, for example, if the new IP address needed indication is not specified (e.g., is set to FALSE). The security policies may be saved and used to determine if a security procedure (e.g., the Direct Link Security Mode procedure) may (e.g., needs to) be run (e.g., enable security on the control plane and/or user plane, if it was not already enabled).

The relay may send back to the S-WTRU a response message (e.g., Link Modification Accept message), (for example to indicate an acceptation of the request to modify the (e.g., PC5) unicast link/direct communication) including/containing the IP address associated with the newly registered S-WTRU's user information and/or application ID.

When sending (e.g., PC5) signaling messages or traffic related to a specific application over the (e.g., PC5) unicast link/direct communication, the S-WTRU may use the IP address associated with this application and (e.g., PC5) unicast link/direct communication.

The T-WTRU may discover the S-WTRU's IP address using a request (e.g., DNS Query Request) that is sent to the relay and specifying the S-WTRU's user information associated with the needed application ID, and/or application ID.

The relay may reply to the T-WTRU by sending the S-WTRU's IP address associated with the specified user information and/or application ID.

In an alternative embodiment, new (e.g., PC5) signaling messages may be introduced instead of using modified request/response messages (e.g., Link Modification Request/Accept messages).

It is to be noted that the procedures to add the support of an application to an existing (e.g., PC5) unicast link/direct communication, which is described herein using a WTRU-to-WTRU relay, alternately may be used with a direct (e.g., PC5) unicast link) (e.g., direct (e.g., PC5) unicast link between two WTRUs without the use of a relay).

5.2 Details of Scalable Support for WTRU-to-WTRU Relay

5.2.1 Provisioning Related to the Support of a New Application Over an Existing Unicast Link

In an embodiment, the WTRU may be provisioned with, e.g., the supported application IDs and security policies. A new parameter may be added to indicate if an application ID is allowed to be used together with other applications on the same (e.g., PC5) unicast link/direct communication and categorizes applications that are allowed to share a (e.g., PC5) unicast link/direct communication.

Alternately, instead of establishing a new (e.g., PC5) unicast link/direct communication, new parameters may be added to an existing (e.g., PC5) unicast link/direct communication. For example, the following parameters may be added:
Sharing/Affinity: this parameter may indicate whether a WTRU may re-use an existing (e.g., PC5) unicast link/direct communication using this application ID (e.g., enabled, disabled); and/or
Class: this parameter may indicate a class (e.g., category or group) that is used to allow applications to be used on a shared (e.g., PC5) unicast link/direct communication. For example, any (e.g., all) applications that may use (e.g., require) full security protection on the control plane and user plane may be configured with “Class=A”, other applications that may not use (e.g., require) any security protection but may accept security protection may be configured with “Class=B”, and applications that do not want to run over a protected (e.g., PC5) unicast link/direct communication may be configured with “Class=C”, and so on. Other parameters may be considered while setting a Class. For example, the Quality of Service (QoS) or privacy requirements may be considered. Applications that may use (e.g., require) privacy may not be classified as applications which may not use (e.g., require) privacy, and may not be authorized to share a (e.g., PC5) unicast link/direct communication.

When a new application is started, the WTRU may verify whether an already established (e.g., PC5) unicast link/direct communication may be re-used for this application. In an embodiment, the WTRU may verify the new application's affinity and its class compared with the already established (e.g., PC5) unicast links/direct communications. An affinity or anti-affinity rule between two particular applications dictates whether these two applications can, respectively, share or not share the same (e.g., PC5) unicast link/direct communication. If no existing (e.g., PC5) unicast link/direct communication may be re-used, e.g., because the affinity does not allow it or because the classes do not match, then the WTRU may establish a new (e.g., PC5) unicast link/direct communication. Otherwise, the WTRU may add the support of this new application to the existing (e.g., PC5) unicast link/direct communication, for example, using the procedure as described in the next section.

5.2.2 Adding the Support of a New Application at the Relay

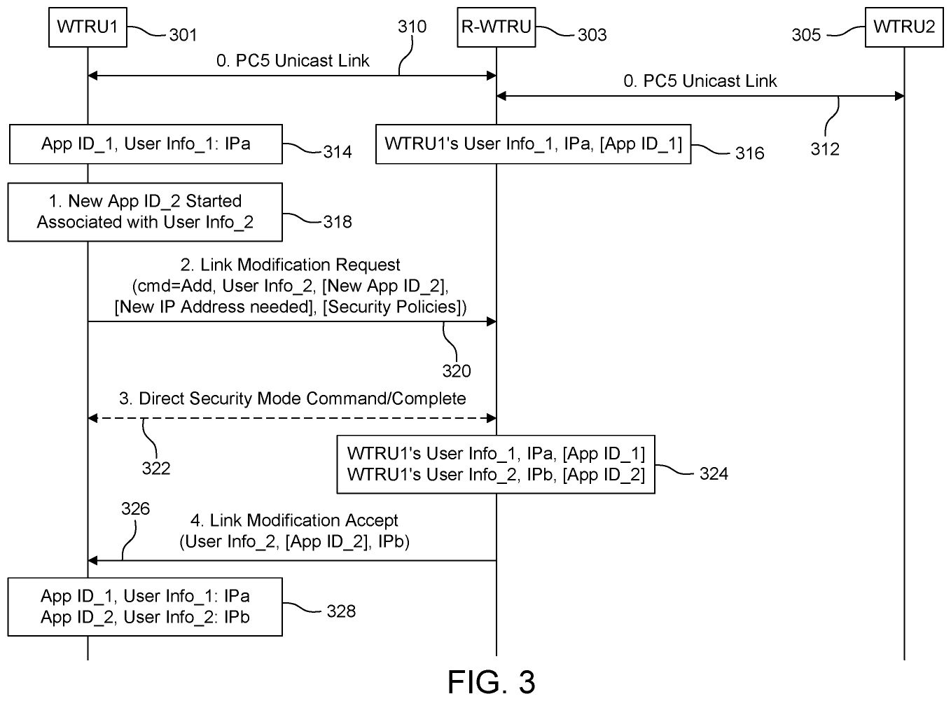

With reference to the signal flow diagram of FIG. 3, the following procedure details the steps, at the S-WTRU and at the L3 WTRU-to-WTRU relay, enabling the usage of a new application via an existing (e.g., PC5) unicast link/direct communication established with a specific relay in accordance with an embodiment. The same procedure may be repeated with any (e.g., all) relays with which the S-WTRU has already established a (e.g., PC5) unicast link/direct communication to support other application(s).

WTRU1 301 (e.g., WTRU 102b) and WTRU2 305 (e.g., WTRU 102c) have established a direct communication (e.g., PC5 unicast link) with the relay R-WTRU 303 (e.g., WTRU 102a) (at 310, 312, respectively). This may be performed in a conventional manner. WTRU1 301 (e.g., WTRU 102b) may keep track of (e.g., store/save) the IP address obtained from the relay R-WTRU 303 (e.g., WTRU 102a) and associated with the (e.g., PC5) unicast link/direct communication, App ID (e.g., App ID_1), and WTRU1's user information (e.g., User Info_1) (314).

The relay R-WTRU 303 (e.g., WTRU 102a) may keep track of (e.g., store/save) WTRU1's user information and/or may keep track of (e.g., store/save) the associated application ID (316).

At 318, a new application may be started on WTRU1 301 (e.g., WTRU 102b) which may verify the affinity and class as described above. WTRU1 301 (e.g., WTRU 102b) may send a request message (e.g., Link Modification Request message) 320 to the relay R-WTRU 303 (e.g., WTRU 102a) to add the support of this application on an existing (e.g., PC5) unicast link/direct communication with a relay. The request message (e.g., Link Modification Request message) may include a new command, for example, value “Add application support,” WTRU1's user information associated with the new application, and/or the new application ID and may specify a “new IP address needed” indication.

WTRU1 301 (e.g., WTRU 102b) may specify the security policies for the added application in the request message (e.g., Link Modification Request message). In the case where the added application may use (e.g., require) security protection, for (e.g., PC5) signaling and/or user traffic, and the security protection is not enabled or is not meeting the new application security policies, WTRU1 301 (e.g., WTRU 102b) may specify the security policies in the request message (e.g., Link Modification Request message). If the (e.g., PC5) unicast link/direct communication link meets the security policies of the new application, the security policies may be omitted. The new application may be associated with different QoS parameters. In this case the QoS parameters may (e.g., need to) be modified, for example, in the subsequent link modification procedure as described below.

Although only shown for one relay in FIG. 3, it will be understood that WTRU1 301 (e.g., WTRU 102b) may send such a request message (e.g., Link Modification Request message) to any (e.g., every) relay with which a (e.g., PC5) unicast link/direct communication may be established to register its new user information and/or application ID.

The relay R-WTRU 303 (e.g., WTRU 102a) may receive the request message (e.g., Link Modification Request message) 320 and may associate WTRU1's new user information (and/or application ID) with this (e.g., PC5) unicast link/direct communication, and possibly new QoS parameters (in addition to the existing user information and/or application ID already registered) (324). If the new IP address indication is specified (e.g., is set to TRUE), a new IP address may be assigned to WTRU1 301 (e.g., WTRU 102b) (in addition to the existing IP address associated with the (e.g., PC5) unicast link/direct communication) and correlated with the new registered user information and/or application ID.

The existing IP address associated with the (e.g., PC5) unicast link/direct communication may be associated with the new user information and/or application ID, for example, if the new IP address (e.g., needed) indication is not specified (e.g., is set to FALSE) and/or no new IP address is provided by WTRU1 301 (e.g., WTRU 102b).

If a new IP address is specified by WTRU1 301 (e.g., WTRU 102b) on the request message (e.g., Link Modification Request message), this new IP address may be saved locally at the relay R-WTRU 303 (e.g., WTRU 102a) and/or associated with the new user information and/or application ID (part of step 324).

The request message (e.g., Link Modification Request message) may also include security parameters to re-establish security for the current (e.g., PC5) unicast link/direct communication. The new security parameters may be included in addition to the security policy. The new security parameters and the security policy may be included if the security policy for the new application is different from the current security policy of the (e.g., PC5) unicast link/direct communication. The security parameters included in the request message (e.g., Link Modification Request message) may be any of: Key establishment container, Nonce, Key session id (e.g., MSB of Knrp-sess ID), and Knrp ID etc.

For example, if security policies are received, the relay R-WTRU 303 (e.g., WTRU 102a) may save them as well as the new security parameters received in the request message (e.g., Link Modification Request message) and may compare them with the security that is established on the (e.g., PC5) unicast link/direct communication. If the requirements for new policies are not fulfilled, the relay R-WTRU 303 (e.g., WTRU 102a) may trigger a new security establishment with WTRU1 301 (e.g., WTRU 102b) (at 322). If no security was previously enabled on the (e.g., PC5) unicast link/direct communication and/or Knrp ID is not specified on the request message (e.g., Link Modification Request message), the relay R-WTRU 303 (e.g., WTRU 102a) may trigger the authentication procedure, for example, before triggering the security establishment procedure.

For example, the (e.g., PC5) unicast link/direct communication may have no security protection enabled since the applications running over this (e.g., PC5) unicast link/direct communication may not use (e.g., require) security protection. In another example, there already may be some insufficient security enabled, e.g., integrity and confidentiality protection on the control plane and none on the user plane. The new application may use (e.g., require) full protection on both the control plane and the user plane or may be ok with lowering overall security level e.g., (e.g., due to the need) to conserve network resources.

If the required security cannot be established (e.g., because the relay R-WTRU 303 (e.g., WTRU 102a) does not have adequate resources available and/or has a different policy profile for this application or the policy is not compatible with the existing security applied on the existing (e.g., PC5) unicast link/direct communication) or if the authentication procedure fails (e.g. because of lack of resources), the request message (e.g., Link Modification Request message) may be rejected, and the new application support may not be added.

In a case where there are no security issues that cannot be resolved, the relay R-WTRU 303 (e.g., WTRU 102a) may send back a response message (e.g., Link Modification Accept message) 326 to WTRU1 301 (e.g., WTRU 102b), for example, including/containing the IP address associated with the newly registered WTRU1's user information and/or application ID. The user information and/or application ID may be included with the agreed QoS parameters for the modified (e.g., PC5) unicast link/direct communication and/or the agreed user plane security protection. WTRU1 301 (e.g., WTRU 102b) may save the data (328).

### Additional Details/Alternatives

In an embodiment, if the support of multiple new applications is (e.g., needs) to be added to the (e.g., PC5) unicast link/direct communication, these may be specified together in the same message (e.g., Link Modification Request). In such a case, the relay R-WTRU 303 (e.g., WTRU 102a) may reply with a response message (e.g., link Modification Accept) that indicates which new application(s) were added successfully along with their associated IP address(es).

A reject message (e.g., Link Modification Reject message) may be sent if none of the applications specified in the request message are added successfully.

A request (e.g., the DNS Query Request) message (e.g., step 6 in FIG. 2) may specify an application ID in addition to the WTRU's user information. In such case, the relay R-WTRU 303 (e.g., WTRU 102a) may fetch the entry that has matching user information and/or application ID values.

In the case of direct WTRU-WTRU communication, this (e.g., Link Modification) procedure may be used to add the support of other applications to an already established (e.g., PC5) unicast link/direct communication. For example, WTRU1 301 (e.g., WTRU 102b) may have a (e.g., PC5) unicast link/direct communication established with WTRU2 305 (e.g., WTRU 102c). WTRU1 301 (e.g., WTRU 102b) may wanton use another application (App2) with the same user. WTRU1 301 (e.g., WTRU 102b) may send a request message (e.g., Link Modification Request message) to add App2 directly to WTRU2 305 (e.g., WTRU 102c). WTRU2 305 (e.g., WTRU 102c) may accept the addition of App2 and reply with response message (e.g., Link Modification Accept message), which may include its user information, and/or its IP address, related to App2.

5.2.3 Removing the Support of an Application at the Relay

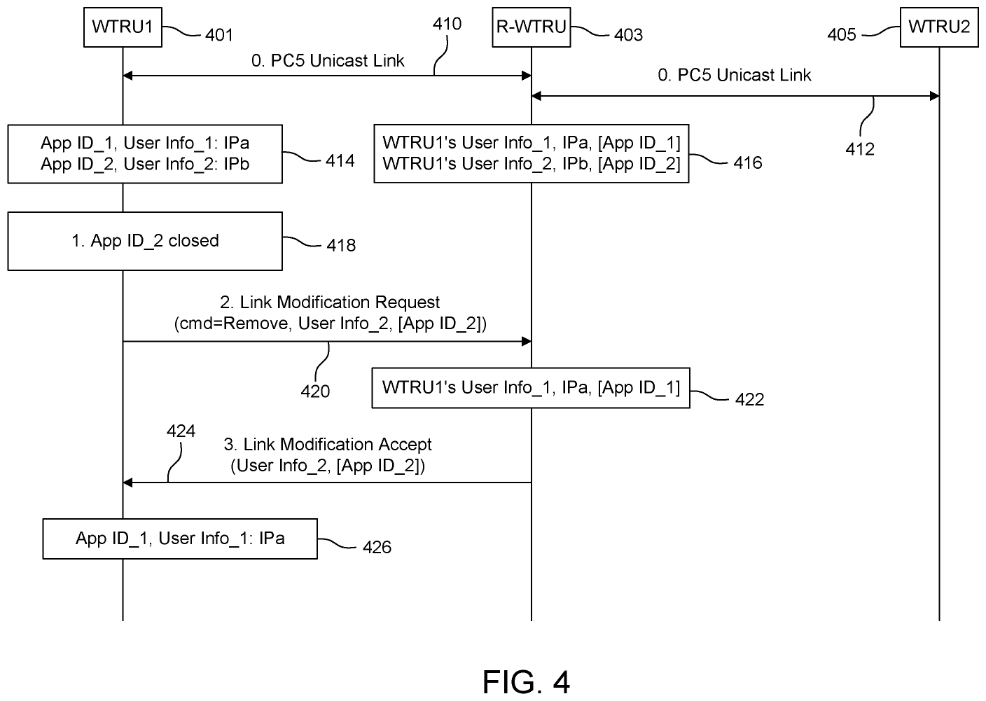

With reference to the signal flow diagram of FIG. 4, the following procedure details the steps, at WTRU1 and the L3 WTRU-to-WTRU relay, of removing/disabling the support of a specific application via an existing (e.g., PC5) unicast link/direct communication established with a specific relay in accordance with an embodiment. The same procedure may be repeated with any (e.g., all) relays with which WTRU1 has already established a (e.g., PC5) unicast link/direct communication and with which the application(s) to be removed are supported.

WTRU1 401 (e.g., WTRU 102b) and WTRU2 405 (e.g., WTRU 102c) may have established a (e.g., PC5) unicast link/direct communication with the relay R-WTRU 403 (e.g., WTRU 102a) (at 410, 412, respectively). This may be performed in a conventional manner. In this example, WTRU1 401 (e.g., WTRU 102b) may have registered the support of two applications (e.g., App ID_1, App ID_2) with the relay.

WTRU1 401 (e.g., WTRU 102b) may have obtained a specific IP address per App ID (e.g., IPa and IPb), as represented at 414. In a case where sending (e.g., PC5) signaling messages or traffic related to a specific application over the (e.g., PC5) unicast link/direct communication, WTRU1 401 (e.g., WTRU 102b) may use the IP address associated with this application and may send the message over the (e.g., PC5) unicast link/direct communication.

The relay R-WTRU 403 (e.g., WTRU 102a) may maintain a mapping between the (e.g., PC5) unicast link/direct communication, the user information, and/or the application ID (416).

If an application is closed on WTRU1 401 (e.g., WTRU 102b) (at 418). WTRU1 401 (e.g., WTRU 102b) may transmit a request message (e.g., Link Modification Request message) 420 to the relay R-WTRU 403 (e.g., WTRU 102a) to remove the support of an application ID on an existing (e.g., PC5) unicast link/direct communication.

The request message (e.g., Link Modification Request message) 420 may include any of: a new command, for example value “remove application support” request, the WTRU's user information associated to the closed application, and the application ID. Although only one is illustrated in FIG. 4, it should be understood that WTRU1 401 (e.g., WTRU 102b) may send such a request message (e.g., Link Modification Request message) to any (e.g., every) relay with which a (e.g., PC5) unicast link/direct communication is associated with the application ID to be removed.

In a case where (e.g., upon) receiving the request message (e.g., Link Modification Request message), the relay R-WTRU 403 (e.g., WTRU 102a) may fetch the associated entry (e.g., from its mapping table) based on WTRU1's user information (and/or application ID). The user information and/or application ID may be removed from the mapping table, e.g., they are not associated anymore with the (e.g., PC5) unicast link/direct communication (422). The QoS parameters and/or security protection may also be updated for the (e.g., PC5) unicast link/direct communication.

If the IP address associated with this entry, e.g., associated with this user information and/or application ID, is specific to this entry (e.g., is not shared with other user info/Application IDs), then the IP address may be released. If, the IP address is shared with other entries, then the IP address may be preserved.

If there is no user information and/or application ID associated with the (e.g., PC5) unicast link/direct communication remaining after the removal of the specified user information and/or application ID, the relay R-WTRU 403 (e.g., WTRU 102a) may trigger a release procedure (e.g., the PC5 unicast Link Release procedure) on the (e.g., PC5) unicast link/direct communication. The relay R-WTRU 403 (e.g., WTRU 102a) may reply by sending a response message (e.g., Link Modification Accept message) 424, that may include the user information and/or application ID that have been removed. WTRU1 401 (e.g., WTRU 102b) may forget (e.g., remove) the IP address that was associated with the closed application (426).

### Additional Details/Alternatives

In an embodiment, in a case where (e.g., when) an application is closed, WTRU1 401 (e.g., WTRU 102b) may determine whether a request message (e.g., Link Modification Request message) message should be sent (e.g., other user/Application IDs are associated with the (e.g., PC5) unicast link/direct communication) or a request message to release the (e.g., PC5) unicast link/direct communication) (e.g., Link Release Request message) may be sent instead (in the case where no more application ID and/or user information are associated with the (e.g., PC5) unicast link/direct communication).

As for the support of a new application for an existing (e.g., PC5) unicast link/direct communication, the removal of an application may change the needed security protection for the (e.g., PC5) unicast link/direct communication. In this case, a procedure to secure the (e.g., PC5) unicast link/direct communication) (e.g., the Direct Security Mode procedure) (step 322, FIG. 3) may be executed after the removal of an application. It may be run during the modification of the (e.g., PC5) unicast link/direct communication) (e.g., Link Modification procedure) (e.g., after step 420 and before step 424) or any time after step 424.

5.2.4 Triggering the Support of a New Application at the Relay from a Peer WTRU Via Indirect Link Modification Procedure

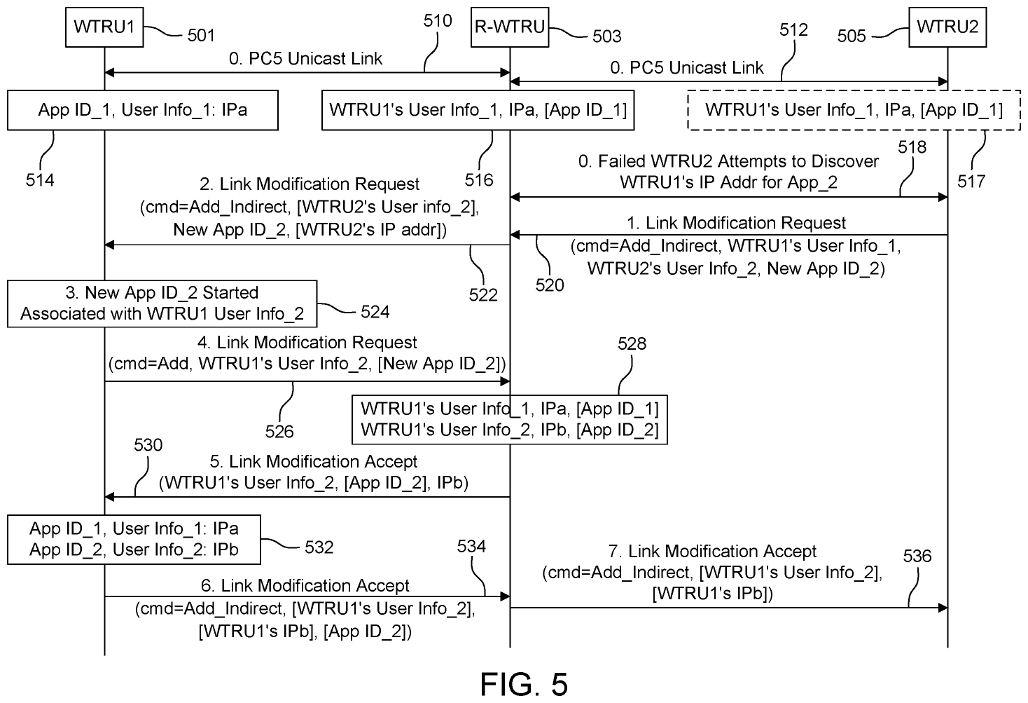

With reference to the signal flow diagram of FIG. 5, the following procedure details the steps, at WTRU1, WTRU2, and at the L3-WTRU-to-WTRU relay that triggers the use of a new application at another WTRU via an existing (e.g., PC5) unicast link/direct communication established with a specific relay.

WTRU1 501 (e.g., WTRU 102b) and WTRU2 505 (e.g., WTRU 102c) may have established a direct (e.g., PC5) unicast link/direct communication with the relay R-WTRU 503 (e.g., WTRU 102a) (at 510, 512, respectively).

WTRU1 501 (e.g., WTRU 102b) may keep track of (e.g., store/save) the IP address obtained from the relay R-WTRU 503 (e.g., WTRU 102a) and associated with the (e.g., PC5) unicast link/direct communication, App ID (e.g., App ID_1) and/or WTRU1's user information (e.g., User Info_1) (514).

The relay R-WTRU 503 (e.g., WTRU 102a) may maintain a mapping between any of the (e.g., PC5) unicast link/direct communication, the user information, the associated IP address and/or the application ID (516).

Optionally, WTRU2 505 (e.g., WTRU 102c) may have obtained WTRU1's IP address related to App ID_1 or WTRU1's User Info_1. WTRU1 501 (e.g., WTRU 102b) and WTRU2 505 (e.g., WTRU 102c) exchange traffic related to App ID 1 (517).

In this example, at 518, WTRU2 505 (e.g., WTRU 102c) may want to use App ID_2 with WTRU1 501 (e.g., WTRU 102b) but may fail to discover the IP address of WTRU1 501 (e.g., WTRU 102b) in the context of a different App ID (e.g., App ID 2).

WTRU2 505 (e.g., WTRU 102c) may send a request message (e.g., Link Modification Request message) 520 to the relay R-WTRU 503 (e.g., WTRU 102a) to (e.g., indirectly) request the support of this previously unsupported application (e.g., App ID_2) on WTRU1 501 (e.g., WTRU 102b) via the relay R-WTRU 503 (e.g., WTRU 102a). WTRU2 505 (e.g., WTRU 102c) may know WTRU1's user associated with, e.g., App ID_1.

The request message (e.g., Link Modification Request message) 520 may include any of: a new command, for example, value “Add Indirect application support”, WTRU1 user information associated with the existing application (App ID 1), the new application ID (App ID 2), WTRU2 user information associated with App ID_2, and may include other parameters, for example, as defined in section 5.2.2.

Relay WTRU 503 (e.g., WTRU 102a) may find the (e.g., PC5) unicast link/direct communication associated with WTRU1's user information as specified in the request 520 and may send a request message (e.g., Link Modification Request message) 522 to WTRU1 501 (e.g., WTRU 102b), (e.g., indirectly) requesting the support of this previously unsupported application (e.g., App ID_2).

The request message (e.g., Link Modification Request message) 522 may include any of: a new command (for example, value “Add Indirect application support”), WTRU1 user information associated with the existing application, and may include WTRU2 user information associated with the existing application (e.g., App ID_1), WTRU2 user information and WTRU2 IP address associated with the new application ID (e.g., App ID_2).

WTRU1 501 (e.g., WTRU 102b) may receive the request and may accept the use of App ID_2. The new application (e.g., App ID_2) may be started on WTRU1 501 (e.g., WTRU 102b) (at 524).

WTRU1 501 (e.g., WTRU 102b) may send a request message to modify the (e.g., PC5) unicast link/direct communication) (e.g., Link Modification Request message) 526 to the relay R-WTRU 503 (e.g., WTRU 102a) (for example, as described in section 5.2.2) to add the support of this application on an existing (e.g., PC5) unicast link/direct communication with a relay (e.g., on the same (e.g., PC5) unicast link/direct communication that was used by the relay R-WTRU 503 (e.g., WTRU 102a) to send the (e.g., “Add indirect application support”) request to WTRU1 501 (e.g., WTRU 102b)).

WTRU1 501 (e.g., WTRU 102b) may keep track of (e.g., store/save) WTRU2's user information and/or the IP address associated with App ID_2. This may allow WTRU1 501 (e.g., WTRU 102b) to skip the (e.g., DNS query) operation to learn WTRU2's IP address.

In a case where (e.g., upon) receiving the request message (e.g., Link Modification Request message) 526, the relay R-WTRU 503 (e.g., WTRU 102a) may associate WTRU1's new user information (and/or application ID) to this (e.g., PC5) unicast link/direct communication, in addition to the existing user information and/or application ID already registered (for example, as described in section 5.2.2) (528).

The relay R-WTRU 503 (e.g., WTRU 102a) may send back a response message (e.g., Link Modification Accept message) 530 to WTRU1 501 (e.g., WTRU 102b).

WTRU1 501 (e.g., WTRU 102b) may save/store the data for the new application (532) and/or may send a message indicating an acceptation of the modification (e.g., a Link Modification Accept message) 534 to the relay R-WTRU 503 (e.g., WTRU 102a), thus closing the (e.g., intermediate inner) Request/Accept loop (e.g., as a response to step 522).

Relay WTRU 503 (e.g., WTRU 102a) may send a response message (e.g., Link Modification Response message) 536 to WTRU2 505 (e.g., WTRU 102c) confirming that the (e.g., Indirect Add) procedure to add the support of this application is completed and that the support of App ID_2 on WTRU1 501 (e.g., WTRU 102b) via the relay R-WTRU 503 (e.g., WTRU 102a) is completed. Optionally, relay R-WTRU 503 (e.g., WTRU 102a) may include WTRU1's user information and IP address associated with App ID_2.

WTRU2 505 (e.g., WTRU 102c) may keep track of (e.g., store/save) WTRU1's user information and/or the IP address associated with App ID_2. This may allow WTRU2 505 (e.g., WTRU 102c) to skip the (e.g., DNS query) operation to learn WTRU2's IP address.

### Alternatives

Alternatively, WTRU1 501 (e.g., WTRU 102b) may establish a new (e.g., PC5) unicast link/direct communication with the relay R-WTRU 503 (e.g., WTRU 102a) at step 526 instead of adding the support of App ID_2 to an existing (e.g., PC5) unicast link/direct communication.

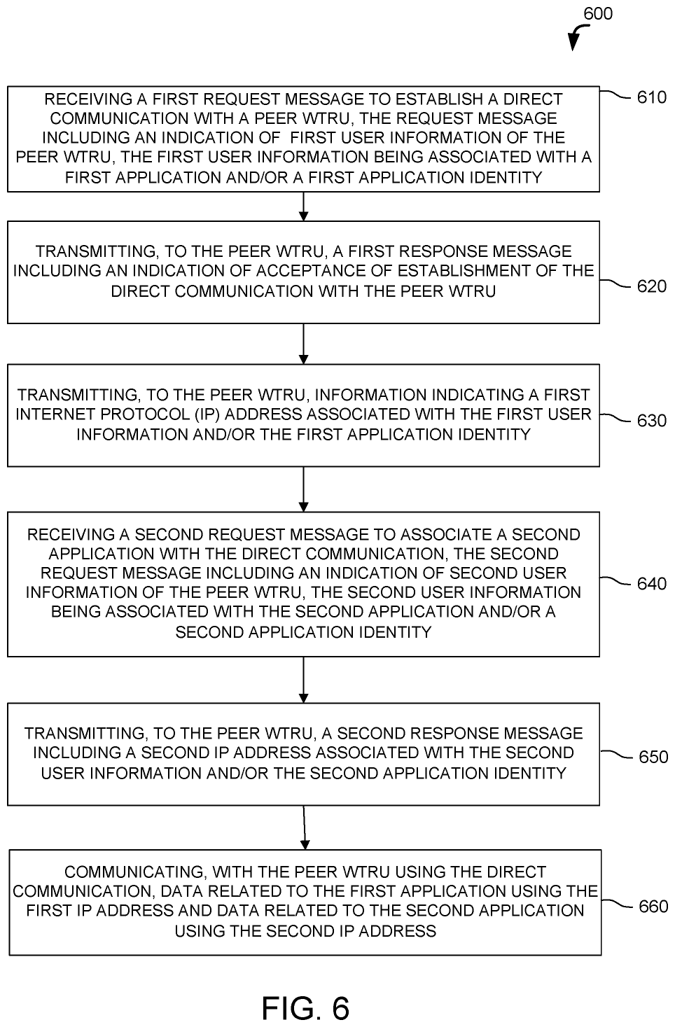

FIG. 6 is a flowchart illustrating a representative method implemented by a WTRU 102a illustrating the addition of support of a new application to a direct communication/unicast link between the WTRU 102a and a peer WTRU 102b.

Referring to FIG. 6, the representative method 600 may include, at block 610, receiving a first request message to establish a direct communication with a peer WTRU 102b, the request message including an indication of first user information of the peer WTRU 102b, the first user information being associated with a first application and/or a first application identity. At block 620, the WTRU 102a may transmit to the peer WTRU 102b, a first response message including an indication of acceptance of establishment of the direct communication with the peer WTRU 102b. At block 630, the WTRU 102a may transmit to the peer WTRU 102b, information indicating a first IP address associated with the first user information and/or the first application identity. At block 640, the WTRU 102a may receive a second request message to associate a second application with the direct communication, the second request message including an indication of second user information of the peer WTRU 102b, the second user information being associated with the second application and/or a second application identity. At block 650, the WTRU 102a may transmit to the peer WTRU 102b, a second response message including a second IP address associated with the second user information and/or the second application identity. At block 660, the WTRU 102a may communicate, with the peer WTRU 102b using the direct communication, data related to the first application using the first IP address and data related to the second application using the second IP address.

In certain representative embodiments, the second IP address may correspond to the first IP address.

In certain representative embodiments, the second IP address may correspond to a new allocated IP address.

In certain representative embodiments, the representative method 600 may include receiving information indicating an allocation of a new IP address associated with the second user information and/or the second application identity.

In certain representative embodiments, the representative method 600 may include storing the second user information and/or the second application identity in association with the second IP address.

In certain representative embodiments the second request message may include security information, and the representative method 600 may include transmitting, to the peer WTRU 102b, information indicating to trigger at the peer WTRU 102b, a security establishment procedure using the security information received, for example, on condition that the security information received differs from stored security information associated with the direct communication.

In certain representative embodiments, the representative method 600 may include transmitting, to the peer WTRU 102b, information indicating to trigger at the peer WTRU 102b, an authentication procedure, for example, on condition that the direct communication is not security protected.

In certain representative embodiments, the second request message may be received from the peer WTRU 102b.

In certain representative embodiments, the representative method 600 may include relaying, by the WTRU 102a, the communicated data, related to the first and second applications: (1) to the peer WTRU 102b via the direct communication between the WTRU 102a and the peer WTRU 102b or (2) from the peer WTRU 102a via a further direct communication between the WTRU 102a and a further peer WTRU 102c.

In certain representative embodiments, the second request message may be received from the further peer WTRU 102c.

In certain representative embodiments, the direct communication may be a PC5 unicast communication.

In certain representative embodiments, the representative method 600 may include the second request message is a PC5 signaling Link Modification Request message and/or the second response message is a PC5 signaling Link Modification Accept message.

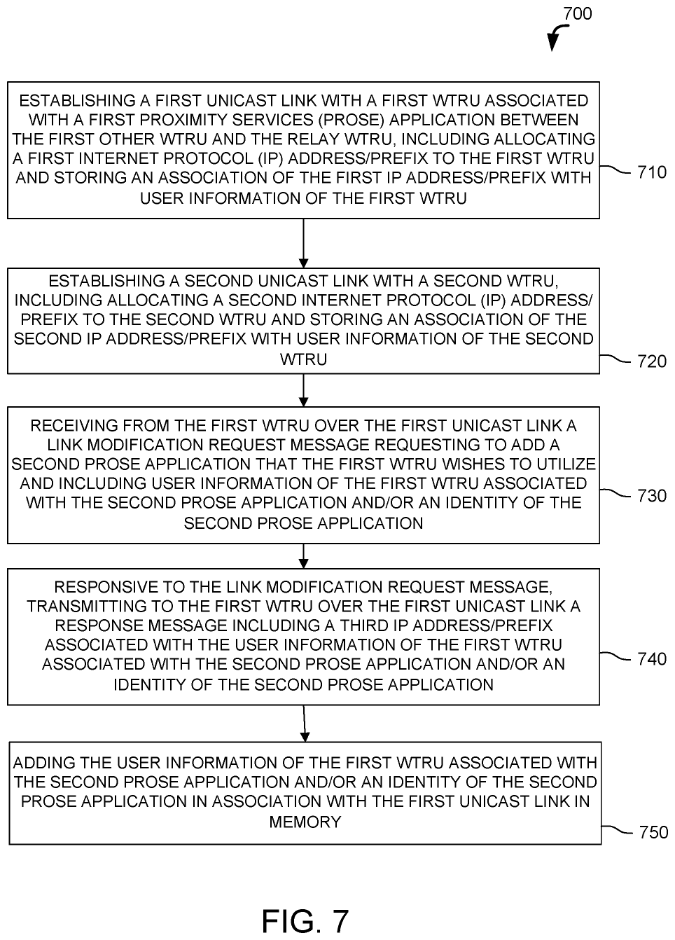

FIG. 7 is a flowchart illustrating a representative method implemented by a relay WTRU 102a, for relaying communications between first and second other WTRUs (102b, 102c).

Referring to FIG. 7, the representative method 700 may include, at block 710, establishing a first unicast link with a first WTRU associated with a first Proximity Services (ProSe) Application between the first other WTRU 102b and the relay WTRU 102a, including allocating a first Internet Protocol (IP) address/prefix to the first WTRU 102b and/or storing an association of the first IP address/prefix with user information of the first WTRU 102b. At block 720, the relay WTRU 102a may establish a second unicast link with a second WTRU 102c, including allocating a second Internet Protocol (IP) address/prefix to the second WTRU 102c and storing an association of the second IP address/prefix with user information of the second WTRU 102c. At block 730, the relay WTRU 102a may receive from the first WTRU 102b over the first unicast link a Link Modification Request message requesting to add a second ProSe Application that the first WTRU 102b wishes to utilize and including user information of the first WTRU 102b associated with the second ProSe Application and/or an identity of the second ProSe Application. At block 740, the relay WTRU 102a, responsive to the Link Modification Request message, may transmit to the first WTRU 102b over the first unicast link a response message including a third IP address/prefix associated with the user information of the first WTRU 102b associated with the second ProSe application and/or an identity of the second ProSe Application. At block 750, the relay WTRU 102a may add the user information of the first WTRU 102b associated with the second ProSe Application and/or an identity of the second ProSe Application in association with the first unicast link in memory.

In certain representative embodiments, the unicast links may be PC5 unicast links.

In certain representative embodiments, the Link Modification Request message may be a PC5 signaling message.

In certain representative embodiments, the response message may be a PC5 signaling Link Modification Accept message.

In certain representative embodiments, the representative method 700 may include relaying data between the first WTRU 102b and the second WTRU 102c related to the first and second ProSe Applications via the same unicast link between the relay WTRU 102a and the first WTRU 102b.

In certain representative embodiments, the representative method 700 may include determining if the second ProSe Application requires security measures that differ from the security measures in place for the first ProSe Application; and/or conducting a security establishment procedure with the first WTRU 102b if the second ProSe Application requires security measures that differ from the security measures in place for the first ProSe Application.

Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a Wireless Transmit Receive Unit (WTRU), the method comprising:
receiving, from a peer WTRU, a first request message to establish a direct communication with the peer WTRU, the first request message including an indication of first user information of the peer WTRU, the first user information being associated with a first application and/or a first application identity;
transmitting, to the peer WTRU, a first response message including an indication of acceptance of establishment of the direct communication with the peer WTRU;
transmitting, to the peer WTRU, information indicating a first Internet Protocol (IP) address associated with the first user information and/or the first application identity;
receiving, from the peer WTRU, a second request message to associate a second application with the direct communication, the second request message including an indication of second user information of the peer WTRU, the second user information being associated with the second application and/or a second application identity;
transmitting, to the peer WTRU, a second response message including a second IP address associated with the second user information and/or the second application identity; and
communicating, with the peer WTRU using the direct communication, data related to the first application using the first IP address and data related to the second application using the second IP address.

2. The method of claim 1, wherein the second IP address corresponds to the first IP address.

3. The method of claim 1, wherein the second IP address corresponds to a new allocated IP address.

4. The method of claim 3, comprising:
receiving information indicating any of an allocation of a new IP address associated with the second user information and the second application identity.

5. The method of claim 1, comprising storing any of the second user information and the second application identity in association with the second IP address.

6. The method of claim 1, wherein the second request message comprises security information, and the method comprising:
receiving, from the peer WTRU, information indicating to trigger a security establishment procedure with the peer WTRU, using the security information received, on condition that the security information received differs from stored security information associated with the direct communication.

7. The method of claim 1, comprising:
receiving, from the peer WTRU, information indicating to trigger an authentication procedure with the peer WTRU, on condition that the direct communication is not security protected.

8. (canceled)

9. The method of claim 1, comprising relaying, by the WTRU, the communicated data, related to the first and second applications: (1) to the peer WTRU via the direct communication between the WTRU and the peer WTRU or (2) from the peer WTRU via a further direct communication between the WTRU and a further peer WTRU.

10-11. (canceled)

12. The method of claim 1, wherein the second request message is any of a PC5 signaling Link Modification Request message and the second response message is a PC5 signaling Link Modification Accept message.

13. A Wireless Transmit/Receive Unit (WTRU) comprising circuitry, including a transmitter, a receiver and a processor, configured to:
receive, from a peer WTRU, a first request message to establish a direct communication with the peer WTRU, the first request message including an indication of first user information of the peer WTRU, the first user information being associated with a first application and/or a first application identity;
transmit, to the peer WTRU, a first response message including an indication of acceptance of establishment of the direct communication with the peer WTRU;
transmit, to the peer WTRU, information indicating a first Internet Protocol (IP) address associated with the first user information and/or the first application identity;
receive, from the peer WTRU, a second request message to associate a second application with the direct communication, the second request message including an indication of second user information of the peer WTRU, the second user information being associated with the second application and/or a second application identity;
transmit, to the peer WTRU, a second response message including a second IP address associated with the second user information and/or the second application identity; and
communicate, with the peer WTRU using the direct communication, data related to the first application using the first IP address and data related to the second application using the second IP address.

14. The WTRU of claim 13, wherein the second IP address corresponds to the first IP address.

15. The WTRU of claim 13, wherein the second IP address corresponds to a new allocated IP address.

16. The WTRU of claim 15, wherein the circuitry is configured to:
receive information indicating any of an allocation of a new IP address associated with the second user information and the second application identity.

17. The WTRU of claim 13, wherein the circuitry comprises a memory configured to store any of the second user information and the second application identity in association with the second IP address.

18. The WTRU of claim 13, wherein the second request message comprises security information, and wherein the circuitry is configured to:
receiving, from the peer WTRU, information indicating to trigger a security establishment procedure with the peer WTRU, using the security information received, on condition that the security information received differs from stored security information associated with the direct communication.

19. The WTRU of claim 13, wherein the circuitry is configured to:
receiving, from the peer WTRU, information indicating to trigger an authentication procedure with the peer WTRU, on condition that the direct communication is not security protected.

20. (canceled)

21. The WTRU of claim 13, wherein the circuitry is configured to relay, by the WTRU, the communicated data, related to the first and second applications: (1) to the peer WTRU via the direct communication between the WTRU and the peer WTRU or (2) from the peer WTRU via a further direct communication between the WTRU and a further peer WTRU.

22-23. (canceled)

24. The WTRU of claim 13, wherein the second request message is any of a PC5 signaling Link Modification Request message and the second response message is a PC5 signaling Link Modification Accept message.
